(19) United States
(12) Patent Application Publication
(10) Pub. No.: US 2006/0282334 A1
(43) Pub. Date: Dec. 14, 2006

(54) RFID-enabled personal shopping assistant system and method

(75) Inventors: Chung-En Kao, Taipei City (TW); Pi-Chuan Hung, Taichung City (TW); Bo-Chen Wu, Hsinchu City (TW); Li-Juen Tseng, Banqiao City (TW); Bing-Chen Kuo, Taipei City (TW)

Correspondence Address: BRUCE H. TROXELL, SUITE 1404, 5205 LEESBURG PIKE, FALLS CHURCH, VA, 22041, US

(73) Assignee: INDUSTRIAL TECHNOLOGY RESEARCH INSTITUTE

(21) Appl. No.: 11/432,623

(22) Filed: May 12, 2006

(30) Foreign Application Priority Data
Jun. 12, 2005 (TW) 094142857

(51) Int. Cl. G06Q 30/00

(52) U.S. Cl. 705/26

(57) ABSTRACT

The present invention relates to a personal shopping assistant system applying radio frequency identification (RFID) technology, i.e. an RFID-enabled personal shopping assistant system. The system of the invention is comprised of a plurality of trade articles, each having an RFID tag attached thereon, at least a mobile device, each having an RIFD reader, and a commodity database, by which a custom service program with real-time personal shopping assistant ability is established. By the RFID-enabled personal shopping assistant system of the invention, a relating method can be established for enabling a service provider to successfully acquire the shopping behavior of its customers so as to proceed with a responsive promotion just in time. Moreover, a consumer can also benefit from the method, that is, a consumer is enabled to rapidly query and obtain his favor goods with respect to his personal preference among a great amount of similar goods. According to the shopping pattern established by the RFID-enabled personal shopping assistant system and method of the invention, not only the time that a consumer wasted in trying to find the goods of his favor can be reduced, but also the correlation between goods and the personal preferences of consumers can be enhanced.

### FIELD OF THE INVENTION

The present invention relates to a shopping system and method, and more particularly, to an RIFD-enabled personal shopping assistant system and method, by which a personalized, real-time and dynamic customer service system can be established basing on trade articles with RFID tags, mobile devices embedded with RFID readers, and a commodity database, for enabling a customer to interact with the commodity data by the mobile device so as to rapidly query and obtain his favor goods with respect to his personal preference among a great amount of similar goods.

### BACKGROUND OF THE INVENTION

Radio frequency identification (RFID) technology is listed as one of the ten most important technologies of the century, which is an automatic identification technology with ability to wireless communication (read and write data without direct contact) and without the necessity for line-of-sight, such that it is convenient, easy to use and well suited for automatic operation and can function under a variety of environment conditions while providing a high level of data integrity. RFID is a technology with bright future and is going to replace the conventional bar coding system for many companies and organizations are trying now to implement RFID in their infrastructure. RFID systems exist in countless variants, produced by many different manufacturers, that can have many applications such as airline luggage monitoring, production automation, warehouse/storage management, transportation monitoring, security control, library management, consumer goods management, e-commerce, mobile communication, hospital administration/management, and so on.

It is more than common that a customer may waste plenty of time trying to find the goods of his favor among an ocean of similar goods in department store or wholesale store, moreover, when he finally finds the goods that he is searching for, it might not have the right size or color fitted to his need. Although there are conventional RFID systems already being implemented in shopping-related applications, the systems with RFID tags attached on trade articles are only designed for the convenience of store management that the RIFD tags are only assessable to the manager of the store and can not interact with consumers for facilitating the shopping operations thereof.

Furthermore, as the competition in consumer market is getting fiercer and fiercer, in order to keep a steady group of loyal customers, many competitors in the consumer market have designed their own VIP membership system distinctive to each other that can be employed as a tool to interact with VIP members while encouraging the VIP members to shop by providing discount thereto. However, each current VIP member system can only record the final shopping result of a VIP member at checking counter, and can not provide the information relating to the whole shopping process of the VIP member, such as, is there any goods that is preferred and intended to purchase by the VIP member, but did not buy in the shopping process.

In addition, although many competitors have try to gather and analyze shopping behaviors of their customers so as to come up with a responsive personalized promotion, the personalized promotion is usually a passive and static promotion that can not be specifically designed to touch the customer in real time. Further that the analysis of shopping behavior is usually biased by the resistance of consumer to popularize his personal preference, and thus the promotion based on the analysis is often out of focus.

Therefore, it is in great need to have a personal shopping assistant system and method applying radio frequency identification (RFID) technology, i.e. an RFID-enabled personal shopping assistant system and method, by which a competitor in the consumer market is enabled to successfully acquire the shopping behavior of its customers so as to proceed with a responsive promotion just in time, and a consumer is enabled to rapidly query and obtain his favor goods with respect to his personal preference among a great amount of similar goods.

### SUMMARY OF THE INVENTION

It is the primary object of the present invention to provide an RIFD-enabled personal shopping assistant system and method, by which a personalized, real-time and dynamic customer service system can be established basing on trade articles with RFID tags, mobile devices embedded with RFID readers, and a commodity database, for enabling a customer to interact with the commodity data by the mobile device so as to rapidly query and obtain his favor goods with respect to his personal preference among a great amount of similar goods.

It is another object of the invention to provide an RIFD-enabled personal shopping assistant system and method, which enable a consumer to establish his personal data on the system, such as color preference, texture/material preference, type of build, etc., for facilitating the same to search his favor goods by the help of RFID and wireless networking technologies, while ensuring the privacy of the consumer.

It is yet another object of the invention to provide an RIFD-enabled personal shopping assistant system and method, which enables a service provider to successfully acquire the shopping behavior of its customers so as to establish the correlation between goods and the personal preferences of consumers.

To achieve the above objects, the present invention provides an RIFD-enabled personal shopping assistant system, which comprises:
at least a trade articles, each having an RFID tag embedded with an identification code representing the trade article the RFID tag attached to;
at least a mobile device, each having an RIFD reader attached thereon, capable of recoding a customer information relating to a consumer; and
a commodity database management system, being comprises of a commodity database recording a commodity data relating to the trade article;
wherein, the identification code is accessed by the RFID reader for enabling the same to query and receive the commodity data recoded in the commodity database accordingly, and thus the mobile device is enabled to compare the received commodity data with the customer information for making an evaluation for determining whether the trade article is suitable to the consumer.

Preferably, the mobile device is a device selected from the group consisting of a personal digital assistant and a handheld communication device.

Preferably, the RFID reader is arranged on an extend interface card coupled to the mobile device. Moreover, the extend interface card can be a secure digit (SD) card.

Preferably, the RIFD-enabled personal shopping assistant system further comprises a server, capable of providing a commodity purchasing module to be downloaded by each mobile device. Moreover, the commodity purchasing module is a module selected from the group consisting of a clothing purchasing module, an ornament purchasing module, a household purchasing module and the combinations thereof, and can be a java program.

Preferably, the RIFD-enabled personal shopping assistant system further comprises a server, capable of providing a consumer preference database for recording shopping data of the consumer.

Preferably, the commodity data of a trade article includes size, color and other specifications; and the customer information of a consumer includes type and measures of body build, other characters and preferences.

Preferably, the mobile device further comprises a user interface to be used by the consumer to establish the customer information into the mobile device. Moreover, the user interface is a java compatible interface.

Furthermore, to achieve the above objects, the present invention provides an RIFD-enabled personal shopping assistant method, which comprises steps of:
attaching RFID tags to trade articles of a shopping area, each RFID tag being embedded with an identification code representing the trade article the RFID tag attached to;
establishing a commodity database for enabling each trade article to correspond to a commodity data resided in the commodity database;
enabling a consumer to use a mobile device, having an RFID reader arranged therein and a customer information established therein, to read the identification code of the RFID tag of a selected trade article while transmitting the identification code to the commodity database;
enabling the commodity data to search the commodity data corresponding to the received identification code and then transmit the search result to the mobile device;
enabling the mobile device to compare the received commodity data of the search result to the customer information established in the mobile device while using the comparison as a base of evaluation for determining whether the selected trade article is suitable to the consumer.

Preferably, the RIFD-enabled personal shopping assistant method further comprises:
recording a shopping data of the consumer, obtained from the evaluation, into a consumer preference database to be employed as a tool for customer management.

Preferably, the RIFD-enabled personal shopping assistant method further comprises:
downloading a specific purchasing module from a server into the mobile device.

Preferably, the RIFD-enabled personal shopping assistant method further comprises:
enabling the consumer to establish the customer information in the mobile device by a user interface compatible to java script.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a schematic diagram depicting the architecture of an RFID-enabled personal shopping assistant system according to a preferred embodiment of the invention.

FIG. 2 is a schematic diagram depicting the architecture of a commodity database management system used by an RFID-enabled personal shopping assistant system of the invention.

FIG. 3 is a schematic diagram depicting the architecture of a membership management system used by an RFID-enabled personal shopping assistant system of the invention.

FIG. 4 is functional block diagram of a mobile device used in an RFID-enabled personal shopping assistant system of the invention.

FIG. 5 is a flow chart depicting an RFID-enabled personal shopping assistant method according to the present invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

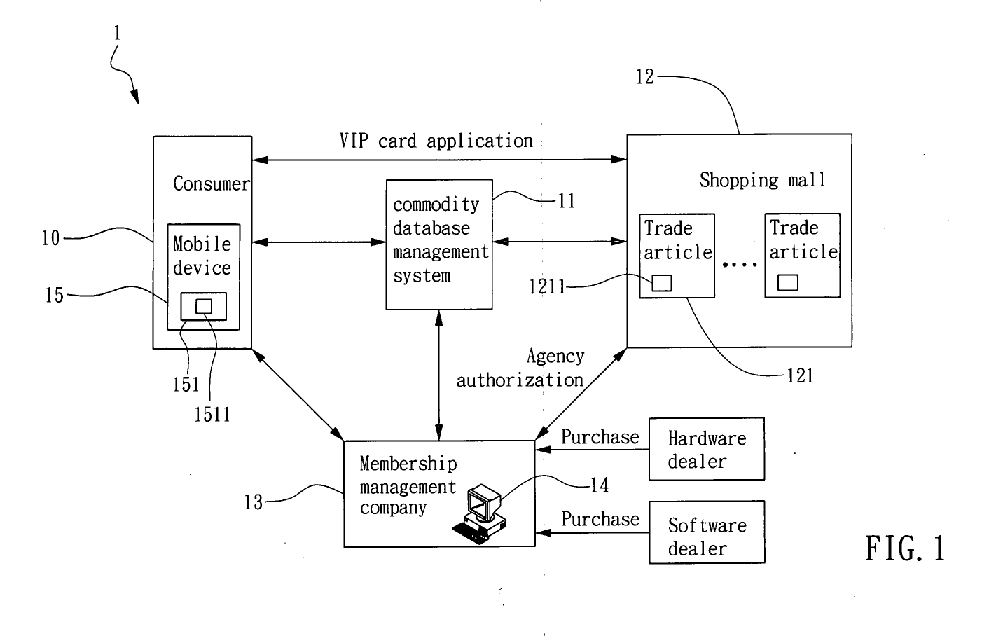

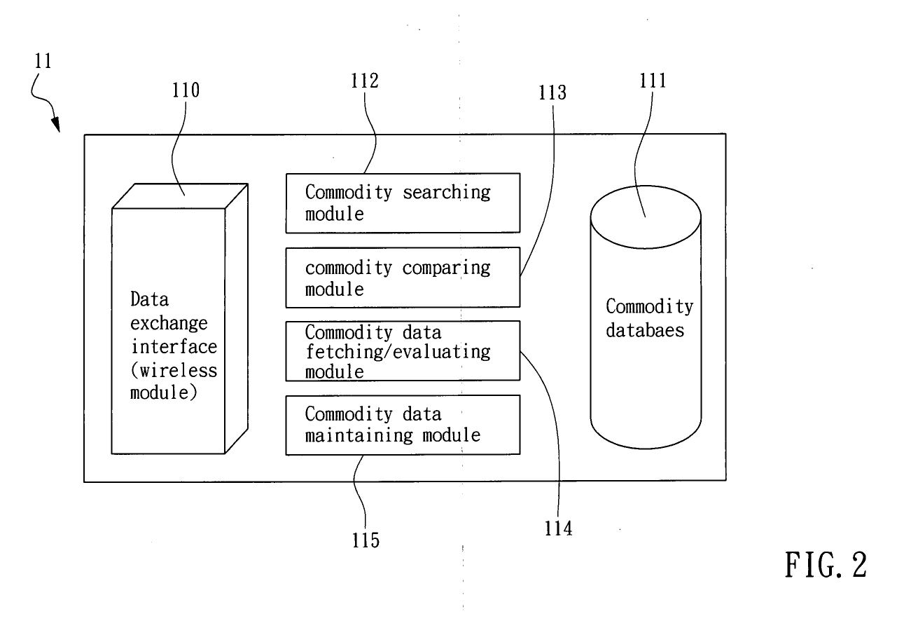

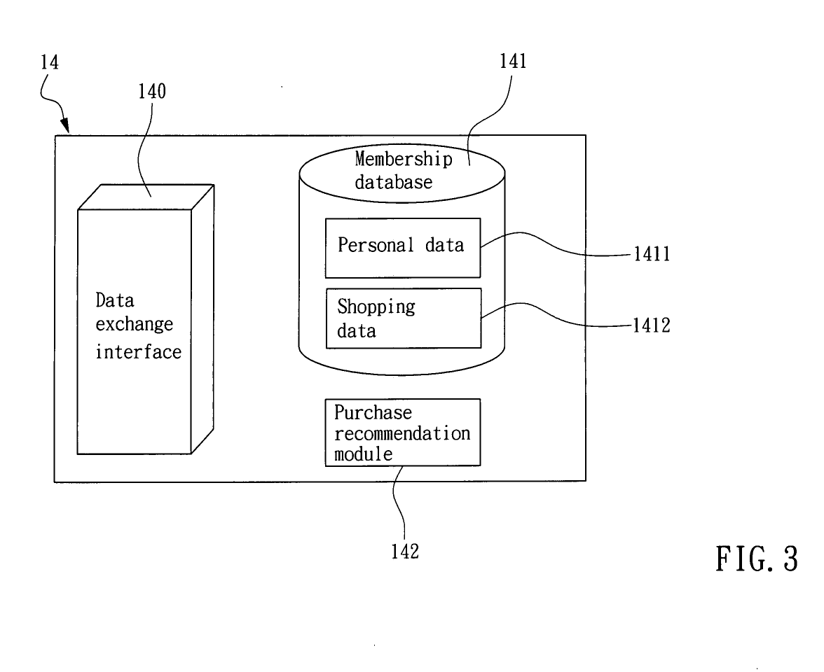

Please refer to FIG. 1, which is a schematic diagram depicting the architecture of an RFID-enabled personal shopping assistant system according to a preferred embodiment of the invention. The RFID-enabled personal shopping assistant system 1, adapted for a shopping mall 12, is comprised of: a plurality of trade articles 121 of the shopping mall 12, each trade article 121 having an RFID tag 1211 embedded with an identification code representing the trade article 121 the RFID tag 1211 attached to; a plurality of mobile devices 15, each being adapted for a consumer 10 and each capable of accepting a VIP card 151 recoding a customer information relating to the consumer 10; and a commodity database management system 11 as shown in FIG. 2, including a data exchange interface 110 and a commodity database 111 recording a commodity data relating to a corresponding trade article 121; wherein each VIP card 151 has an RIFD reader 1511 arranged therein, and the identification code of a selected trade article 121 is accessed by the RFID reader 1511 of the mobile device 15 used by the consumer 10 for enabling the same to query and receive the commodity data of the selected trade article 121 recoded in the commodity database 111 accordingly, and thus the mobile device 15 is enabled to compare the received commodity data with the customer information for making an evaluation to determine whether the selected trade article 121 is suitable to the consumer 10. In the preferred embodiment shown in FIG. 1, the shopping mall 12 authorizes a membership management company 13 to manage the application and issuing VIP cards 151 to its loyal customers, i.e. members. The membership management company 13 uses a membership management system 14, as shown in FIG. 3, to exchange data required by the RFID-enabled personal shopping assistant system 1 and the plural consumers 10 as authorized by the shopping mall 12. The membership management system 14 of FIG. 3 further comprises a data exchange interface 140 and a membership database 141; wherein the data exchange interface 140 can be a wireless communication module, and the membership database is used to store information relating each member of the shopping mall 1, such as his personal data 1411, his personal shopping data 1412, and his preferences, etc. In addition, the membership management system 14 further comprises a purchase recommendation module 142 for providing shopping recommendations to each member.

Please refer to FIG. 2, which is a schematic diagram depicting the architecture of a commodity database management system 11 used by an RFID-enabled personal shopping assistant system 1 of the invention. The commodity database management system 11 comprises a data exchange interface 110 and a commodity database 111; wherein the data exchange interface 110 can be a wireless communication module, and the commodity database 111 is used to store detail commodity data corresponding to the identification code of each trade article 121 in the shopping mall 12, including size, color and other specifications of each trade article 121. Moreover, the commodity database management system 11 further comprises a commodity searching module 112, a commodity comparing module 113, a commodity fetching/evaluating module 114 and a commodity maintaining module 115.

In the embodiment shown in FIG. 1, the VIP card 151 is a secure digit (SD) card, which is capable of coupling to the mobile device 15. It is noted that although SD card is used as the VIP card of the invention, it is not limited thereby and can be other interface cards such as mini-SD, etc. As the shopping mall 12 authorizes the membership management company 13 to issue its VIP cards 151 to consumers 10, the membership management company 13 will seek qualified hardware and software dealers to purchase required services and equipment therefrom.

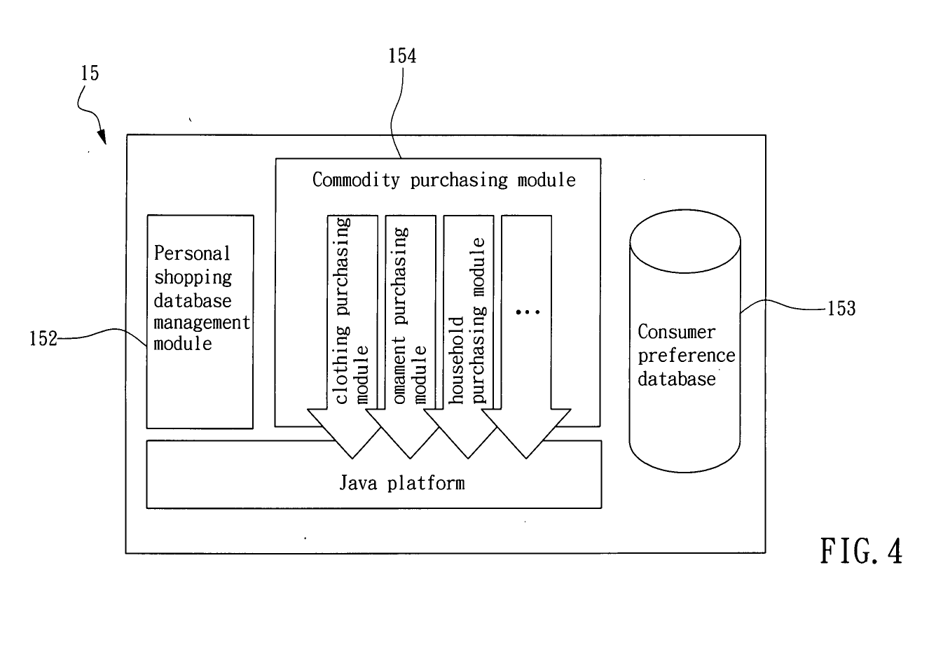

Please refer to FIG. 4, which is functional block diagram of a mobile device used in an RFID-enabled personal shopping assistant system of the invention. As seen in FIG. 4, each mobile device 15 further comprises a consumer preference database 153, in which the preferences of a consumer 10 using the mobile device 15 can be established by the used of a personal shopping database management module 152 of a java platform arranged in the mobile device 15, and the preferences of the consumer 10 includes color preference, texture/material preference, type and measures of body build, and so on. It is noted that the consumer preference database 153 can be stored in the memory of the mobile device 15 or the memory of the VIP card 151 received in the mobile device 15. Moreover, for saving memory needed in either the mobile device 15 or the VIP card 151, a commodity purchasing module 154 can be downloaded from a sever by the consumer 10 only as needed, whereas the commodity purchasing module 154 is a java program selected form the group consisting of a clothing purchasing module, an ornament purchasing module, a household purchasing module and the combinations thereof. It is further noted that the aforesaid server can be a server used in the membership management system 14 or a server used in the commodity database management system 11.

Operationally, the mobile device 15 is capable of vastly interrogating the identification codes of trade articles 121 in the shopping mall 12 for enabling the same to query and receive the commodity data of the trade articles 121 recoded in the commodity database 111 of the commodity database management system 11 accordingly, and thus the mobile device 15 is enabled to compare the received commodity data with the customer information for making an evaluation to determine whether the interrogated trade articles 121 are suitable to the consumer 10 using the mobile device 15.

The major participants of the RFID-enabled personal shopping assistant system 1 includes the consumer 10, the shopping mall 12 and the membership management company 13, whose characters and obligations can be summed up as following:
(1) The shopping mall 12 is in charge of the issuing of VIP cards.
(2) The commodity database management system 11 is operating by the shopping mall 12 itself.
(3) The membership management company 13 receives the authorization from the shopping mall 12 to manage the personal data of its members.
(4) The membership management company 13 is responsible to provide VIP cards 151 to the shopping mall 12.
(5) The membership management company 13 is in charge of the operation of the membership management system 14.
(6) The custom information relating to consumer preferences stored in each VIP card is established by the consumer himself.

The aforementioned major participants with their characters and obligations are only an embodiment of the invention, and are nit limited thereby. For instance, the customer service department of the shopping mall 12 can replace the membership management system 14 to run the membership management company 13. Moreover, The issuing and management of the VIP card can be handled by the shopping mall without the help of the membership management company 13.

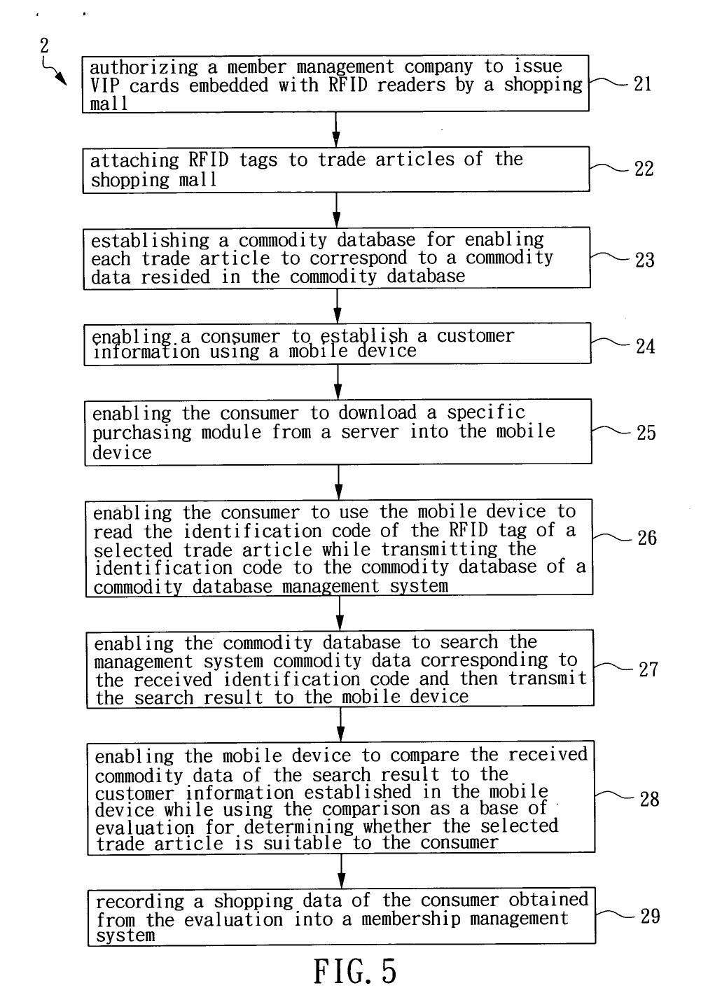

Please refer to FIG. 5, which is a flow chart depicting an RFID-enabled personal shopping assistant method according to the present invention. The method begins at the step 21. In the step 21, a shopping mall authorizes a member management company to issue VIP cards embedded with RFID readers and also to establish a membership management system for filing the identification code of each VIP card and basic information of it members into a membership database; and then the flow proceeds to step 22.

In step 22, in corresponding to each trade article in the shopping mall, a unique identification code is established and stored in an RFID tag whereas the RFID tag is attached to the corresponding trade article, and then the flow proceeds to step 23. In step 23, a commodity database is established for enabling each trade article to correspond to a commodity data resided in the commodity database while each commodity data includes size, color, specification, manufacturer, etc. and then the flow proceeds to step 24. It is noted that the commodity data establishment performed in step 22 and step 23 can be done by the suppliers the shopping mall. After the establishment of commodity data is done, the shopping mall only need to assembly the established data into its commodity database.

In step 24, the preferences of a consumer using the mobile device can be established by the used of a java platform of the mobile device, whereas the preferences of the consumer including color preference, texture/material preference, type and measures of body build, etc., can be stored in a consumer preference database, and then the flow proceeds to step 25. It is noted that the consumer preference database can be stored in the memory of the mobile device or the memory of the VIP card received in the mobile device. In step 25, the consumer is going to download a specific java purchasing module from a membership management system into the mobile device according to the type of trade article he is going to purchase, whereas the commodity purchasing module 154 is a java program selected form the group consisting of a clothing purchasing module, an ornament purchasing module, a household purchasing module and the combinations thereof, and then the flow proceeds to step 26.

In step 26, the consumer use the mobile device to read the identification code of the RFID tag of a selected trade article while transmitting the identification code wirelessly to the commodity database management system, and then the flow proceeds to step 27. In step 27, the commodity database management system is enabled to search the commodity data corresponding to the received identification code and then transmit wirelessly the search result to the mobile device, and then the flow proceeds to step 28.

In step 28, the mobile device is going to compare the received commodity data of the search result to the customer information established in the mobile device while using the comparison as a base of evaluation for determining whether the selected trade article is suitable to the consumer, and then the flow proceeds to step 29. In step 29, after a suitable trade article is located and purchased by the consumer, a shopping data of the consumer obtained from the result of the evaluation is record into a membership management system with respect to the unique membership number of the consumer so as to be employed as a tool for customer management. In addition, a recommendation can be made by the membership management system during the purchasing of the consumer according to the recoded custom information of the consumer preference database.

To sum up, the RFID-enabled personal shopping assistant system and method of the invention not only can reduce the time that a consumer wasted in trying to find the goods of his favor, but also can enhance the correlation between goods and the personal preferences of consumers while maintain the privacy of its customers.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An RIFD-enabled personal shopping assistant system, comprising:
at least a trade articles, each having an RFID tag embedded with an identification code representing the trade article the RFID tag attached to;
at least a mobile device, each having an RIFD reader attached thereon, capable of recoding a customer information relating to a consumer; and
a commodity database management system, being comprises of a commodity database recording a commodity data relating to the trade article;
wherein, the identification code of a selected trade article is accessed by the RFID reader for enabling the same to query and receive the commodity data of the selected trade article recoded in the commodity database accordingly, and thus the mobile device is enabled to compare the received commodity data with the customer information for making an evaluation to determine whether the selected trade article is suitable to the consumer.

2. The system of claim 1, wherein the mobile device is a device selected from the group consisting of a personal digital assistant and a handheld communication device.

3. The system of claim 1, wherein the RFID reader is arranged on an extend interface card coupled to the mobile device.

4. The system of claim 3, wherein the extend interface card can be a secure digit (SD) card.

5. The system of claim 5, further comprising a server.

6. The system of claim 5, wherein the serve is capable of providing a commodity purchasing module to be downloaded by each mobile device.

7. The system of claim 6, wherein the commodity purchasing module is a clothing purchasing module.

8. The system of claim 6, wherein the commodity purchasing module is an ornamenet module.

9. The system of claim 6, wherein the commodity purchasing module is a household purchasing module.

10. The system of claim 6, wherein the commodity purchasing module is a java program.

11. The system of claim 5, wherein the server is further capable of providing a consumer preference database for recording shopping data of the consumer

12. The system of claim 1, wherein the mobile device further comprises a user interface to be used by the consumer to establish the customer information into the mobile device.

13. The system of claim 1, wherein the user interface is a java compatible interface.

14. An RIFD-enabled personal shopping assistant method, which comprises steps of:
attaching RFID tags to trade articles of a shopping area, each RFID tag being embedded with an identification code representing the trade article the RFID tag attached to;
establishing a commodity database for enabling each trade article to correspond to a commodity data resided in the commodity database;
enabling a consumer to use a mobile device, having an RFID reader arranged therein and a customer information established therein, to read the identification code of the RFID tag of a selected trade article while transmitting the identification code to the commodity database;
enabling the commodity data to search the commodity data corresponding to the received identification code and then transmit the search result to the mobile device; and
enabling the mobile device to compare the received commodity data of the search result to the customer information established in the mobile device while using the comparison as a base of evaluation for determining whether the selected trade article is suitable to the consumer.

15. The method of claim 14, further comprising:
recording a shopping data of the consumer, obtained from the result of the evaluation, into a consumer preference database to be employed as a tool for customer management.

16. The method of claim 14, further comprising:
downloading a specific purchasing module from a server into the mobile device.

17. The method of claim 16, wherein the commodity purchasing module is a clothing purchasing module.

18. The method of claim 16, wherein the commodity purchasing module is an ornament purchasing module.

19. The method of claim 16, wherein the commodity purchasing module is a household purchasing module.

20. The method of claim 14, wherein the commodity purchasing module is a java program.

21. The method of claim 14, wherein the mobile device is a device selected from the group consisting of a personal digital assistant and a handheld communication device.

22. The method of claim 14, wherein the RFID reader is arranged on an extend interface card coupled to the mobile device.

23. The method of claim 14, wherein the commodity data of the trade article includes size, color and other specifications.

24. The method of claim 14, wherein the customer information of the consumer includes type and measures of body build, other characters and preferences.

25. The method of claim 14, further comprising:
enabling the consumer to establish the customer information in the mobile device by a user interface.

26. The method of claim 25, wherein the user interface compatible to java script.
